(19) United States
(12) Patent Application Publication
(10) Pub. No.: US 2015/0220269 A1
(43) Pub. Date: Aug. 6, 2015

(54) STORAGE DEVICE AND OPERATING METHOD THEREOF

(71) Applicants: Sang Hoon LEE, Yongin-si (KR); Dong-Woo KIM, Suwon-si (KR)

(72) Inventors: Sang Hoon LEE, Yongin-si (KR); Dong-Woo KIM, Suwon-si (KR)

(21) Appl. No.: 14/610,513

(22) Filed: Jan. 30, 2015

(30) Foreign Application Priority Data
Feb. 4, 2014 (KR) 10-2014-0012737

(51) Int. Cl. G06F 3/06

(52) U.S. Cl. CPC G06F 3/061; G06F 3/0679; G06F 3/0659; G06F 3/0661; G06F 2206/1014

(57) ABSTRACT

An operating method of a storage device includes receiving an operation request from a host. The method includes interpreting the operation request as one of a multi-plane operation request and a 1-plane operation request. The method includes outputting an operation sequence corresponding to the interpreted operation request. The storage device includes at least one vertical flash memory device and a memory controller to control the at least one vertical flash memory device.

### CROSS-REFERENCE TO RELATED APPLICATIONS

This application claims priority under 35 U.S.C. §119 from Korean Patent Application No. 10-2014-0012737 filed Feb. 4, 2014, in the Korean Intellectual Property Office, the entire contents of which are hereby incorporated by reference.

### BACKGROUND

Inventive concepts described herein relate to storage devices and/or operating methods thereof.

Semiconductor memory devices may be classified as volatile semiconductor memory devices and nonvolatile semiconductor memory devices. Nonvolatile semiconductor memory devices may retain data stored therein even when power is removed. Data stored in a nonvolatile semiconductor memory device may be permanent or reprogrammable, depending upon the fabrication technology used. Nonvolatile semiconductor memory devices may be used for user data, program, and microcode storage in a wide variety of applications in the computer, avionics, telecommunications, and consumer electronics industries.

### SUMMARY

At least one example embodiment of inventive concepts provides an operating method of a storage device. The storage device includes at least one vertical flash memory device and a memory controller to control the at least one vertical flash memory device. The method includes receiving an operation request from a host. The method includes interpreting the operation request as one of a multi-plane operation request and a 1-plane operation request. The includes outputting an operation sequence corresponding to the interpreted operation request.

According to at least one example embodiment of inventive concepts, the interpreted operation request is a 2-plane operation request.

According to at least one example embodiment of inventive concepts, the receiving a multi-plane operation request comprises receiving a first plane start command and an address. The receiving a multi-plane operation request comprises receiving least significant bit (LSB) page data, receiving a transfer completion command for the LSB page data, receiving a second plane start command and an address, receiving most significant bit (MSB) page data; and receiving a transfer completion command for the MSB page data.

According to at least one example embodiment of inventive concepts, the outputting an operation sequence comprises outputting a plane start command and an address, transmitting least significant bit (LSB) page data corresponding to first page data, outputting a page data exchange command, outputting the plane start command and the address after a desired time when a latch operation is performed, transmitting most significant bit (MSB) page data corresponding to second page data, outputting the page data exchange command, and outputting a transfer completion command for the first and second page data after the desired time.

According to at least one example embodiment of inventive concepts, the interpreting the operation request comprises predicting a latch operation.

According to at least one example embodiment of inventive concepts, the interpreting interprets the operation request as the 1-plane operation request if the latch operation is predicted.

According to at least one example embodiment of inventive concepts, the interpreting interprets the operation request as the multi-plane operation request if the latch operation is not predicted.

According to at least one example embodiment of inventive concepts, the predicting a latch operation comprises determining whether or not to perform the latch operation based on a start command having plane-related information from the host.

According to at least one example embodiment of inventive concepts, if the operation request is the multi-plane operation request, a sequence associated with a start command for a first plane does not include a latch operation time, and a sequence associated with a start command for a second plane includes the latch operation time.

According to at least one example embodiment of inventive concepts, the outputting an operation sequence comprises outputting a page data exchange command after at least one page of data is transferred in a high-speed operation.

According to at least one example embodiment of inventive concepts, a storage device comprises at least one vertical NAND flash memory device (VNAND) including a plurality of memory blocks formed of a plurality of strings. The plurality of strings are in a direction perpendicular to a substrate and connected to a bit line, each string of the plurality of strings including at least one string selection transistor, a plurality of memory cells, and at least one ground selection transistor. The storage device includes a memory controller configured to control the at least one VNAND. The memory controller includes a host interface configured to communicate with a host using a NAND protocol, and a VNAND interface configured to communicate with the at least one VNAND using a VNAND protocol. The VNAND interface is configured to interpret an operation request received through the host interface as one of a multi-plane operation request and a 1-plane operation request.

According to at least one example embodiment of inventive concepts, the at least one VNAND supports a high-speed operation mode in which a plurality of page data is programmed to or read from a physical page at one time.

According to at least one example embodiment of inventive concepts, the VNAND interface is configured to determine whether to perform a latch operation based on the operation request received from a host, and interpret the received operation request as the multi-plane operation request or the 1-plane operation request according to the determination result.

According to at least one example embodiment of inventive concepts, the host interface is configured to use a start command that is distinguishable by plane information in the operation request.

According to at least one example embodiment of inventive concepts, the VNAND interface comprises a latency reducing device configured to sense a page data transfer for at least one channel and to issue a page data exchange command for a high-speed operation mode based on the sensing result.

According to at least one example embodiment of inventive concepts, a mobile device comprises an application processor, and a storage device configured to communicate with the application processor via a first NAND interface. The storage device includes at least one vertical NAND flash memory device (VNAND) and a memory controller configured to communicate with the at least one VNAND via a second NAND interface. The NAND interface is configured to interpret an operation request received via the first NAND interface as one of a multi-plane operation request and a 1-plane operation request.

According to at least one example embodiment of inventive concepts, the storage device is a UFS (universal flash storage) device.

According to at least one example embodiment of inventive concepts, the first NAND interface is configured to receive a part of the operation request according to a status of a write buffer.

According to at least one example embodiment of inventive concepts, the second NAND interface is configured to issue at least one page data exchange command in the 1-plane operation request.

According to at least one example embodiment of inventive concepts, the second NAND interface is configured to issue the at least one page data exchange command in response to a transfer completion of write data.

According to at least one example embodiment of inventive concepts, a device comprises a memory controller configured to receive a first sequence of commands for performing an operation on a memory associated with the memory controller, the first sequence of commands being received in accordance with a first protocol. The memory controller is configured to convert the first sequence of commands into a second sequence of commands such that the second sequence of commands is in accordance with a second protocol, different from the first protocol. The memory controller is configured to output the second sequence of commands such that the operation is performed on the memory.

According to at least one example embodiment of inventive concepts, the first protocol is for a planar NAND flash memory device, and the second protocol for a vertical NAND flash memory device.

According to at least one example embodiment of inventive concepts, the received first sequence of commands is a request for performing the operation on a plurality of logical pages of data, and the second sequence of commands is a request for performing the operation on one physical page of data in the memory.

According to at least one example embodiment of inventive concepts, the first sequence of commands is a program operation request including a first start command and a first address of a first logical page of the plurality of logical pages, page data of the first logical page, a transfer completion command for the first logical page, a second start command and a second address of a second logical page of the plurality of logical pages, page data of the second logical page, and a transfer completion command for the second logical page.

According to at least one example embodiment of inventive concepts, the second sequence of commands is a program operation request including a third start command and a first address of the one physical page, the page data of the first logical page, a first page data exchange command for performing a first latch operation, a fourth start command and a second address of the one physical page, the page data of the second logical page, a second data exchange command for performing a second latch operation, and a transfer completion command for the one physical page.

According to at least one example embodiment of inventive concepts, the memory controller is configured to sense a transfer completion of the page data of the first logical page and immediately initiate the first page data exchange command upon sensing the transfer completion.

According to at least one example embodiment of inventive concepts, the memory controller is configured to predict the latch operation, and convert the first sequence of commands into the second sequence of command based on a result of the prediction.

According to at least one example embodiment of inventive concepts, the first start command includes identification information, and the memory controller is configured to predict the latch operation based on the identification information.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram schematically illustrating a storage device according to at least one example embodiment of inventive concepts;

FIG. 2 is a diagram for conceptually describing a high-speed operation of a VNAND shown in FIG. 1;

FIG. 3 is a block diagram schematically illustrating a 2-plane VNAND 100;

FIG. 4 is a perspective view of a memory block of a VNAND according to at least one example embodiment of inventive concepts;

FIG. 5 is a perspective view schematically illustrating a memory block according to at least one example embodiment of inventive concepts;

FIG. 6 is a circuit diagram schematically illustrating an equivalent circuit of a memory block shown in FIG. 5, according to at least one example embodiment of inventive concepts;

FIG. 7 is a flow chart schematically illustrating an operating method of a storage device according to at least one example embodiment of inventive concepts;

FIG. 8 is a diagram schematically illustrating a program sequence according to a 2-plane program operation request provided to a host interface, according to at least one example embodiment of inventive concepts;

FIG. 9 is a diagram schematically illustrating a sequence corresponding to a 1-plane program operation request output from a VNAND interface according to at least one example embodiment of inventive concepts;

FIG. 10 is a flow chart schematically illustrating an operating method of a storage device, according to at least one example embodiment of inventive concepts;

FIG. 11 is a diagram schematically illustrating a program sequence where a 2-plane program operation request of a host is interpreted as a 1-plane program operation request when a latch operation is predicted;

FIG. 12 is a diagram schematically illustrating a program sequence where a 2-plane program operation request of a host is interpreted as a 2-plane program operation request when a latch operation is not predicted;

FIG. 13 is a block diagram schematically illustrating a storage device according to at least one example embodiment of inventive concepts;

FIG. 14 is a diagram for conceptually describing an operation of a latency reducing unit shown in FIG. 13;

FIG. 15 is a diagram schematically illustrating a program sequence of transferring data based on a result of checking whether a buffer is full, in a storage device according to at least one example embodiment of inventive concepts;

FIG. 16 is a block diagram schematically illustrating a storage device according to at least one example embodiment of inventive concepts;

FIG. 17 is a block diagram schematically illustrating a solid state drive according to at least one example embodiment of inventive concepts;

FIG. 18 is a block diagram schematically illustrating an eMMC according to at least one example embodiment of inventive concepts;

FIG. 19 is a block diagram schematically illustrating a UFS system according to at least one example embodiment of inventive concepts; and

FIG. 20 is a block diagram schematically illustrating a mobile device according to at least one example embodiment of inventive concepts.

### DETAILED DESCRIPTION OF EXAMPLE EMBODIMENTS

Inventive concepts will now be described more fully with reference to the accompanying drawings, in which example embodiments of are shown. These example embodiments are provided so that this disclosure will be thorough and complete, and will fully convey inventive concepts of to those skilled in the art. Inventive concepts may be embodied in many different forms with a variety of modifications, and a few embodiments will be illustrated in drawings and explained in detail. However, this should not be construed as being limited to example embodiments set forth herein, and rather, it should be understood that changes may be made in these example embodiments without departing from the principles and spirit of inventive concepts, the scope of which are defined in the claims and their equivalents. Like numbers refer to like elements throughout. In the drawings, the thicknesses of layers and regions are exaggerated for clarity.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Specific details are provided in the following description to provide a thorough understanding of example embodiments. However, it will be understood by one of ordinary skill in the art that example embodiments may be practiced without these specific details. For example, systems may be shown in block diagrams so as not to obscure example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware in existing electronic systems (e.g., electronic imaging systems, image processing systems, digital point-and-shoot cameras, personal digital assistants (PDAs), smartphones, tablet personal computers (PCs), laptop computers, etc.). Such existing hardware may include one or more Central Processing Units (CPUs), digital signal processors (DSPs), application-specific-integrated-circuits (ASICs), field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium”, “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible or non-transitory machine readable mediums for storing information. The term “computer-readable medium” may include, but is not limited to, portable or fixed storage devices, optical storage devices, and various other tangible or non-transitory mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors may be programmed to perform the necessary tasks, thereby being transformed into special purpose processor(s) or computer(s).

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “includes”, “including”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “and/or” includes any and all combinations of one or more of the associated listed items. Expressions such as “at least one of,” when preceding a list of elements, modify the entire list of elements and do not modify the individual elements of the list.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For example, when a device structure (e.g., a memory cell structure or a transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

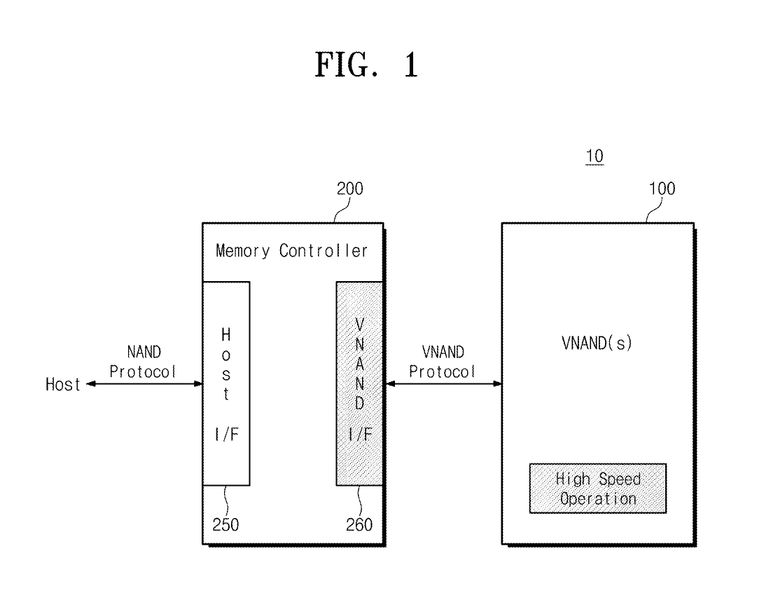

FIG. 1 is a block diagram schematically illustrating a storage device 10 according to at least one example embodiment of inventive concepts. Referring to FIG. 1, a storage device 10 contains at least one vertical NAND flash memory device (hereinafter, referred to as “VNAND”) 100 and a memory controller 200 to control the VNAND 100.

The VNAND 100 may support a high-speed operation mode. Here, the high-speed operation mode means that a plurality of page data is programmed at once during a program operation or that a plurality of page data is read at once during a read operation. The memory controller 200 includes a host interface 250 and a VNAND interface 260.

The host interface 250 is configured to communicate with an external host using a NAND protocol. In at least one example embodiment, the NAND protocol may be a protocol for communicating with a planar (or non-vertical) NAND flash memory device.

The VNAND interface 260 is configured to communicate with the VNAND 100 using the VNAND protocol. The VNAND interface 260 interprets (or changes, or converts) an input/output request (e.g., a program/read/erase request through the NAND protocol) of the host provided to the host interface 250 into the VNAND protocol and transmits the interpreted result to the VNAND 100 using the VNAND protocol. Here, the VNAND protocol may be different from a NAND protocol.

For example, a multi-plane operation request is provided to the host interface 250 from the host according to the NAND protocol, the VNAND interface 260 interprets the multi-plane operation provided to the host interface 250 into a 1-plane operation request according to the VNAND protocol and outputs the interpreted 1-plane (or single-plane) operation request to the VNAND 100. Here, the 1-plane operation request according to the VNAND protocol may support a high-speed operation mode of the VNAND 100.

With the above description, since the storage device 10 according to at least one example embodiment of inventive concepts uses the VNAND 100 internally and a NAND interface (e.g., 250) externally, the storage device 10 may maintain compatibility with a host that uses a conventional planar NAND flash memory device.

Also, the storage device 10 according to at least one example embodiment of inventive concepts supports the VNAND protocol for the VNAND 100 with a high-speed operation mode, thereby improving data input/output performance.

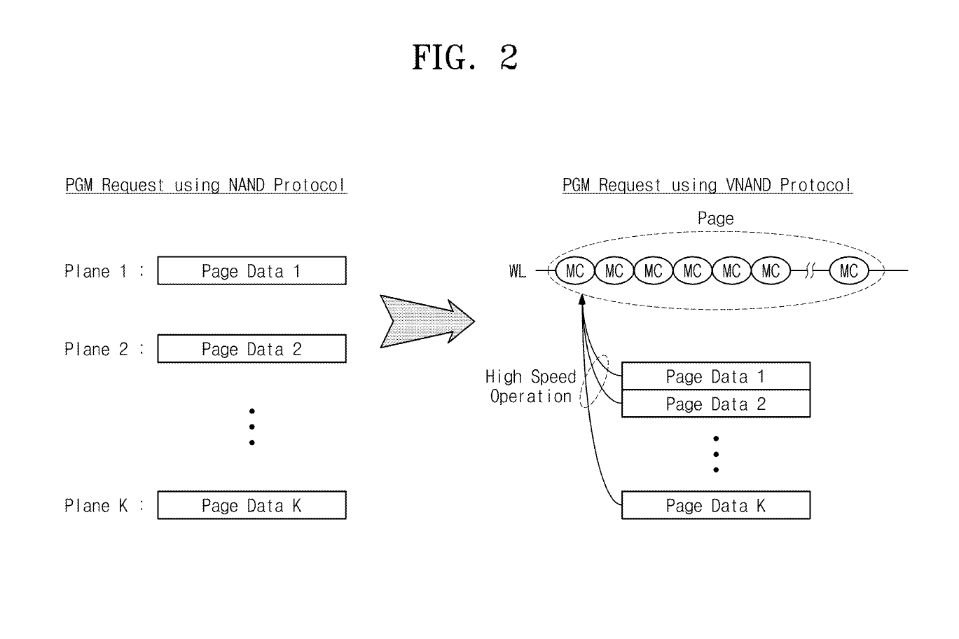

FIG. 2 is a diagram for conceptually describing a high-speed operation of a VNAND 100 shown in FIG. 1. For ease of description, a program operation request will be described with reference to FIG. 2. Referring to FIG. 2, it is assumed that program requests for programming pages of data Page Data 1 to Page Data K (K being an integer of 2 or more) at a plurality of planes Plane 1 to Plane K are received by the memory controller 200 according to a NAND protocol. In this case, such program requests may be interpreted, by a VNAND interface 260 (refer to FIG. 1), as a program request for programming the pages of data Page Data 1 to Page Data K at memory cells MC connected to a word line. That is, the multi-plane program request may be for programming the pages of data Page Data 1 to Page Data K one page at a time. However, in a high-speed program operation for a VNAND 100, the memory controller 200 may interpret multi-plane program request as a 1-plane program request for programming the pages of data Page Data 1 to Page Data K to a single physical page of VNAND 100 at one time (or simultaneously).

Although he high-speed operation mode for a program operation request has been described with reference to FIG. 2, a high-speed operation mode for a read operation request may be performed in a similar manner. That is, the VNAND interface 260 may interpret a read operation request for a plurality of planes according to a NAND protocol as a read operation request for a plurality of logical page data in a single physical page based on the VNAND protocol.

A VNAND 100 may be configured to support a multi-plane operation.

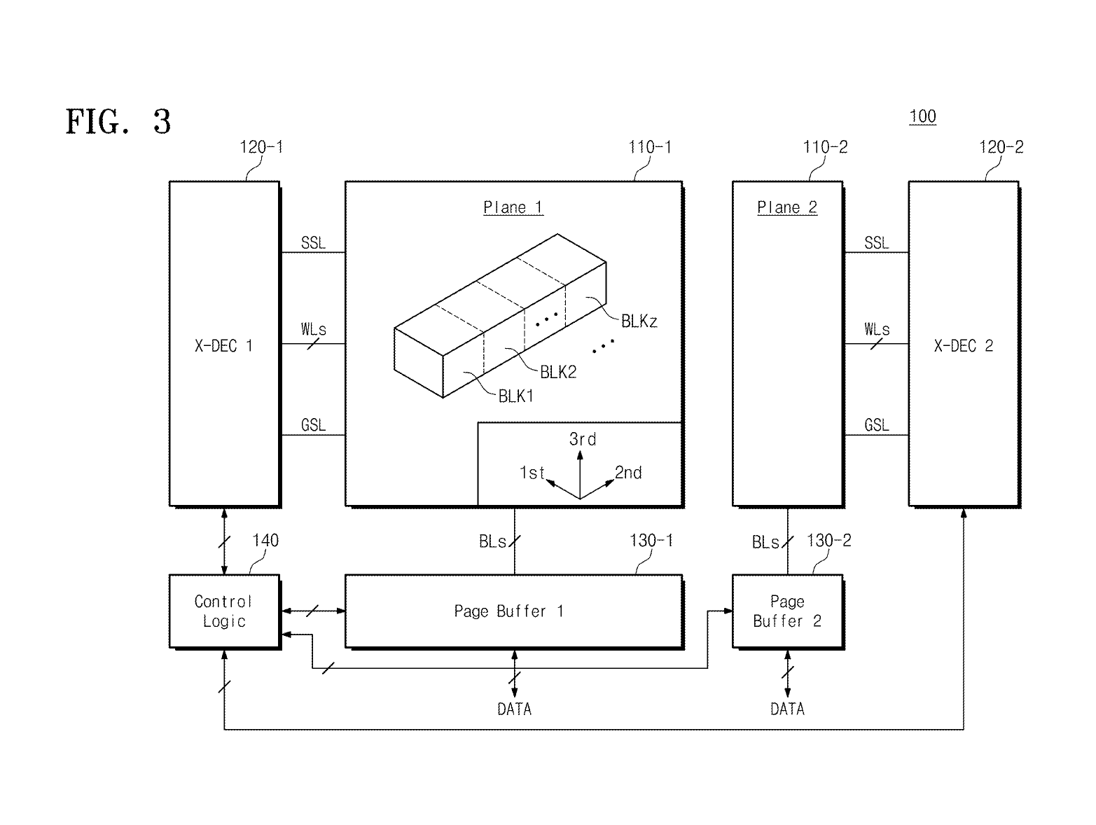

FIG. 3 is a block diagram schematically illustrating a 2-plane VNAND 100. Referring to FIG. 3, a VNAND 100 contains a first plane 110-1, a second plane 110-2, a first address decoder 120-1, a second address decoder 120-2, a first page buffer circuit 130-1, a second page buffer circuit 130-2, and control logic 140.

Each of the first plane 110-1 and the second plane 110-2 includes a plurality of memory blocks BLK1 to BLKz (z being an integer of 2 or more). Each of the memory blocks BLK1 to BLKz may be connected to the an address decoder 120-1 or 120-2 through word lines WLs, at least one string selection line SSL, and at least one ground selection line GSL and to a page buffer circuit 130-1 or 130-2 through bit lines BLs.

The memory blocks BLK1 to BLKz may include a plurality of strings that are three-dimensionally arranged on a substrate along a first direction and a second direction different from the first direction and along a third direction (i.e., a direction perpendicular to a plane formed in the first and second directions). Herein, each string may contain at least one string selection transistor, a plurality of memory cells, and at least one ground selection transistor connected in series in a direction perpendicular to the substrate. Each memory cell may store one or more bits. In at least one example embodiment, at least one dummy cell may be provided between at least one string selection transistor and a plurality of memory cells. As another example, at least one dummy cell may be provided between a plurality of memory cells and at least one ground selection transistor.

In an embodiment of the present inventive concept, a three dimensional (3D) memory array is provided. The 3D memory array is monolithically formed in one or more physical levels of arrays of memory cells having an active area disposed above a silicon substrate and circuitry associated with the operation of those memory cells, whether such associated circuitry is above or within such substrate. The term “monolithic” means that layers of each level of the array are directly deposited on the layers of each underlying level of the array.

In an embodiment of the present inventive concept, the 3D memory array includes vertical NAND strings that are vertically oriented such that at least one memory cell is located over another memory cell. The at least one memory cell may comprise a charge trap layer. Each vertical NAND string may include at least one select transistor located over memory cells, the at least one select transistor having the same structure with the memory cells and being formed monolithically together with the memory cells.

The following patent documents, which are hereby incorporated by reference, describe suitable configurations for three-dimensional memory arrays, in which the three-dimensional memory array is configured as a plurality of levels, with word lines and/or bit lines shared between levels: U.S. Pat. Nos. 7,679,133; 8,553,466; 8,654,587; 8,559,235; and US Pat. Pub. No. 2011/0233648.

Each of the first and second address decoders 120-1 and 120-2 selects one of the memory blocks BLK1 to BLKz in response to an address signal. Each of the first and second address decoders 120-1 and 120-2 is connected to a memory cell array through word lines WLs, at least on string selection line SSL, and at least one ground selection line GSL. Each of the first and second address decoders 120-1 and 120-2 selects the word lines WLs, the at least on string selection line SSL, and the at least one ground selection line GSL using a decoded row address. Each of the first and second address decoders 120-1 and 120-2 decodes a column address of an input address. Here, the decoded column address may be transferred to a page buffer circuit 130-1 or 130-2 via control logic 140. In at least one example embodiment, each of the first and second address decoders 120-1 and 120-2 may include, but not limited to, a row decoder, a column decoder, an address buffer, and so on.

The first and second page buffer circuits 130-1 and 130-2 are connected to the first plane 110-1 and the second plane 110-2 through corresponding bit lines BLs. The first and second page buffer circuits 130-1 and 130-2 are configured to receive the decoded column address from the first and second address decoders 120-1 and 120-2 via the control logic 140. The first and second page buffer circuits 130-1 and 130-2 select the corresponding bit lines using the decoded column address.

The first and second page buffer circuits 130-1 and 130-2 receive data from an external device (e.g., a memory controller 200 in FIG. 1) and store the input data in the first plane 110-1 and the second plane 110-2. The first and second page buffer circuits 130-1 and 130-2 read data from the first plane 110-1 and the second plane 110-2 and output the read data DATA to the external device.

In at least one example embodiment, each of the first and second page buffer circuits 130-1 and 130-2 may store a plurality of page data in a high-speed operation mode. Each of the first and second page buffer circuits 130-1 and 130-2 may include latches (not shown) to store a plurality of page data. A plurality of page data stored in latches of the first page buffer circuit 130-1 may be exchanged with a plurality of page data stored in latches of the second page buffer circuit 130-2, which will be referred to as page data exchange. Below, an operation of exchanging page data between such latches will be referred to as a latch operation.

The control logic 140 controls an overall operation of the VNAND 100, including, but not limited to, a program operation, a read operation, and an erase operation. The control logic 140 operates in response to control signals and commands that are output from the memory controller 200 according to a VNAND protocol. In particular, the control logic 140 may be implemented to support a high-speed operation mode.

For example, in high-speed operation mode for a program operation, the control logic 140 controls an address decoder 120-1 or 120-2 and a page buffer circuit 130-1 or 130-2 such that a plurality of page data is programmed to a physical page according to a program operation request based on the VNAND protocol.

Also, the control logic 140 controls an address decoder 120-1 or 120-2 and a page buffer circuit 130-1 or 130-2 such that a plurality of page data stored to a physical page is read according to a read operation request based on the VNAND protocol and pages of data thus read are sequentially output.

In a high-speed operation mode, the control logic 140 receives a page data exchange command based on the VNAND protocol and controls a page buffer circuit 130-1 or 130-2 in response to the page data exchange command such that page data stored in latches of the page buffer circuit 130-1 or 130-2 is exchanged. For example, in a page data exchange operation, first page data stored in first latches is transferred to second latches, and second page data is provided to the first latches.

Also, the control logic 140 may support a multi-plane operation mode. The control logic 140 receives a multi-plane operation request based on the VNAND protocol and controls an address decoder 120-1 or 120-2 and a page buffer circuit 130-1 or 130-2 according to the multi-plane operation request.

As described above, the VNAND 100 according to at least one example embodiment of inventive concepts may support a high-speed operation mode and a multi-plane operation mode.

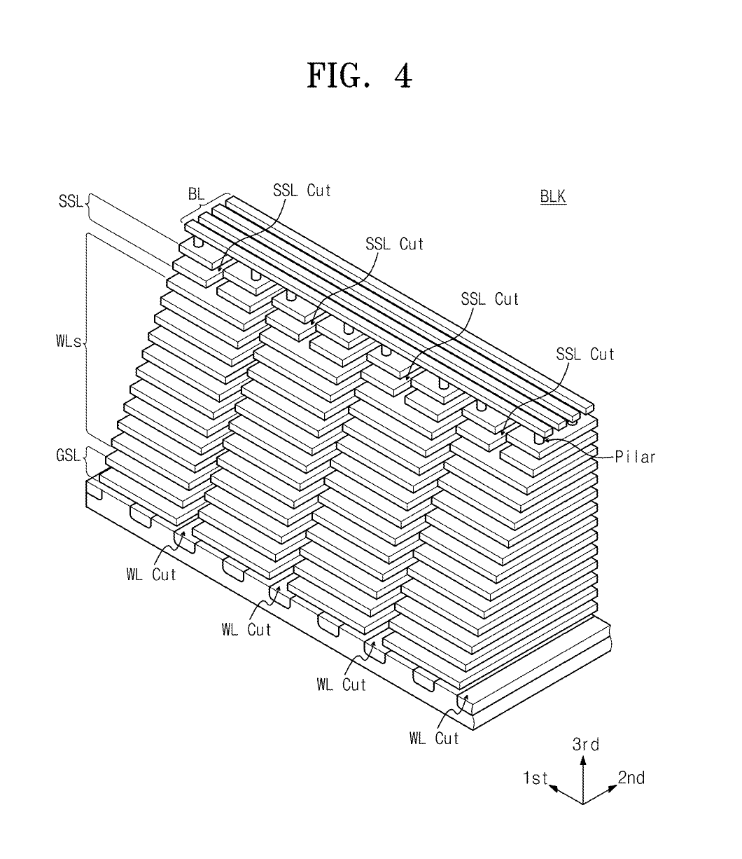

FIG. 4 is a perspective view of a memory block BLK of a VNAND according to at least one example embodiment of inventive concepts. Referring to FIG. 4, four sub blocks are formed on a substrate. Each sub block is formed by stacking and cutting at least one ground selection line GSL, a plurality of word lines WLs, and at least one string selection line SSL on the substrate in a plate shape. Here, the at least one string selection line SSL is separated by string selection line cuts SSL Cut.

In at least one example embodiment, at least one plate-shaped dummy line is formed between the ground selection line GSL and the word lines WLs. Or, at least one plate-shaped dummy line is formed between the word lines and the string selection line SSL.

Although not shown in FIG. 4, each word line cut WL Cut among the sub blocks may include a common source line CSL. In at least one example embodiment, the common source lines CSL included in the word line cuts WL Cut may be interconnected. A string may be formed by making a pillar connected to a bit line BL penetrate the at least one string selection line SSL, the word lines WLs, and the at least one ground selection line GSL.

FIG. 4 illustrates an example embodiment in which a structure between word line cuts adjacent to each other is a sub block. However, inventive concepts are not limited thereto. For example, a structure between a word line cut WL Cut and a string selection line cut SSL Cut may be defined as a sub block.

The memory block BLK according to at least one example embodiment of inventive concepts may be implemented to have a merged word line structure where two word lines are merged into one.

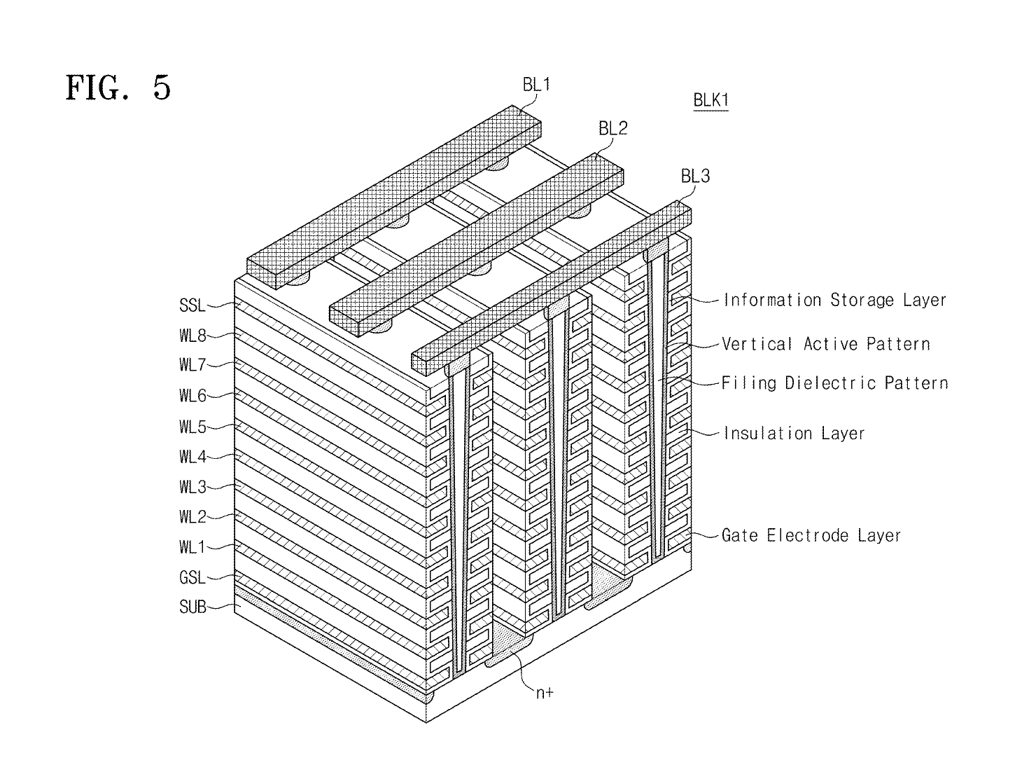

FIG. 5 is a perspective view schematically illustrating a memory block according to at least one example embodiment of inventive concepts. Referring to FIG. 5, a memory block BLK1 is formed in a direction perpendicular to a substrate SUB. An n+ doping region is formed in the substrate SUB.

A gate electrode layer and an insulation layer are deposited on the substrate SUB in turn. An information storage layer is formed between the gate electrode layer and the insulation layer.

If the gate electrode layer and the insulation layer are patterned in a vertical direction, a V-shaped pillar is formed. The pillar is connected to the substrate SUB through the gate electrode layer and the insulation layer. An outer portion of the pillar may be formed of channel semiconductor as a vertical active pattern, and an inner portion of the pillar may be formed of an insulation material such as silicon oxide as a filing dielectric pattern.

The gate electrode layer of the memory block BLK1 is connected to a ground selection line GSL, a plurality of word lines WL1 to WL8, and a string selection line SSL. The pillars of the memory block BLK1 are connected to a plurality of bit lines BL1 to BL3. FIG. 5 illustrates an example where one memory block BLK1 has two selection lines SSL and GSL, eight word lines WL1 to WL8, and three bit lines BL1 to BL3. However, inventive concepts are not limited thereto.

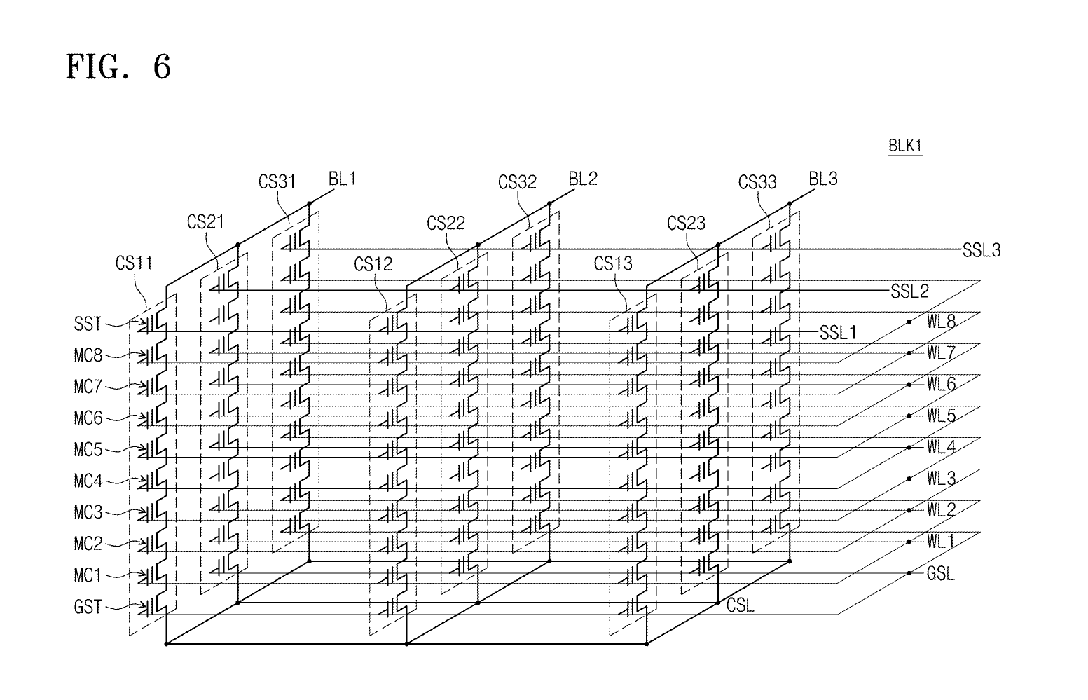

FIG. 6 is a circuit diagram schematically illustrating an equivalent circuit of a memory block BLK1 shown in FIG. 5, according to at least one example embodiment of inventive concepts. Referring to FIG. 6, cell strings CS11 to CS33 may be connected between bit lines BL1 to BL3 and a common source line CSL. Each cell string (e.g., CS11) includes a string selection transistor SST, a plurality of memory cells MC1 to MC8, and a ground selection transistor GST.

The string selection transistors SST are connected to a string selection line SSL. The string selection line SSL are divided into first to third string selection lines SSL1 to SSL3. In FIG. 6, there are illustrated three string selection line SSL1 to SSL3 corresponding to a bit line. However, inventive concepts are not limited thereto. The memory block BLK1 of inventive concepts may be implemented to include at least two string selection lines corresponding to a bit line.

The ground selection transistors GST are connected to a ground selection line GSL. That is, ground selection lines GSL of the cell strings are interconnected. In each cell string, the string selection transistor SST is connected to a bit line, and the ground selection transistor GST is connected to the common source line CSL. The memory block BLK1 shown in FIG. 6 has a structure in which a ground selection line GSL is shared. However, inventive concepts are not limited thereto. Like the string selection lines, the ground selection line may be separated.

In each string, the memory cells MC1 to MC8 are connected to word lines WL1 to WL8, respectively. A set of memory cells that are connected to a word line and are simultaneously programmed is referred to as a page. Accordingly, it may be said that the memory block BLK1 includes a plurality of pages. Also, a word line is connected to a plurality of pages. Referring to FIG. 6, a word line with the same height (e.g., WL4) from the common source line CSL is connected in common to three pages.

Each memory cell may store 1-bit data or two or more bits of data. A memory cell storing 1-bit data may be referred to as a single-level cell (SLC) or a single-bit cell. A memory cell storing two or more bits of data may be referred to as a multi-level cell (MLC) or a multi-bit cell. In a 2-bit MLC, two pages of data may be stored in a physical page. Thus, six pages of data may be stored at memory cells connected to a word line WL4.

A nonvolatile memory device may be implemented with a charge trap flash (CTF) memory. In this case, an initial verify shift (IVS) phenomenon may be generated such that that charges trapped in programmed CTF memory are redistributed and leaked by lapse of time. Reprogramming may be performed to overcome such distribution deterioration.

Below, operating methods of a storage device 10 according to at least one example embodiment of inventive concepts will be more fully described.

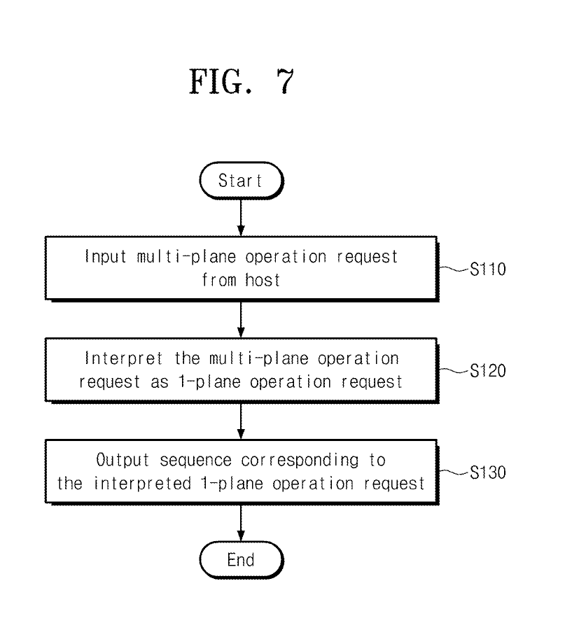

FIG. 7 is a flow chart schematically illustrating an operating method of a storage device 10 according to at least one example embodiment of inventive concepts.

In operation S110, a multi-plane operation request of a host 10 (refer to FIG. 1) based on a NAND protocol is provided to a host interface 250 (refer to FIG. 1) of a memory controller 200 (refer to FIG. 1). In operation S120, A VNAND interface 260 interprets the multi-plane operation request provided to the host interface 250 as a 1-plane operation request based on a VNAND protocol. In operation S130, the VNAND interface 260 outputs a sequence corresponding to the 1-plane operation request. The sequence issued to the VNAND 100 may support a high-speed operation mode of the VNAND 100.

With the operating method of a storage device 10 of inventive concepts, the multi-plane operation request provided from the host may be interpreted as the 1-plane operation request supporting the high-speed operation mode.

Below, there will be described a NAND protocol-based sequence and a VNAND protocol-based sequence upon a multi-plane program operation request.

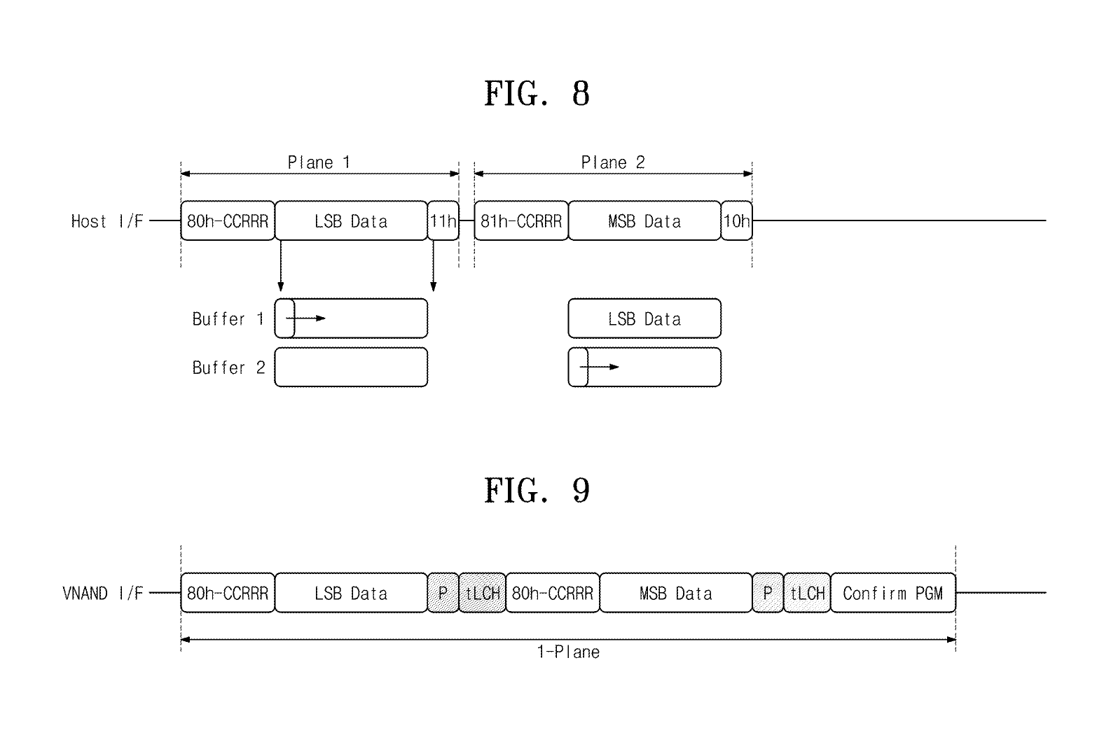

FIG. 8 is a diagram schematically illustrating a program sequence according to a 2-plane program operation request provided to a host interface 250, according to at least one example embodiment of inventive concepts. Referring to FIG. 8, a program sequence is divided into a program operation request for a first plane and a program operation request for a second plane. The first and second planes may be logical planes.

Upon reception of the program operation request for the first plane, as illustrated in FIG. 8, a program sequence start command 80h, an address CCRRR corresponding to a page, LSB page data, and a data transfer completion command (or “1 cycle command”) 11h are sequentially transferred to program LSB page data at the page of the first plane. It should be understood that LSB page data may be correspond to, for example, Page Data 1 in FIG. 2. Here, the data transfer completion command 11h may be transferred after the LSB page data is stored in a first buffer of a memory controller 120 (refer to FIG. 1).

Upon reception of the program operation request to the second plane, as illustrated in FIG. 8, a program sequence start command 81h, an address CCRRR corresponding to a page, MSB page data, and a data transfer completion command (or “2 cycle command”) 10h are sequentially transferred to program MSB page data at the page of the second plane. It should be understood that MSB page data may be correspond to, for example, Page Data 2 in FIG. 2. Here, the data transfer completion command 10h may be transferred after the MSB page data is stored in a second buffer of the memory controller 120 (refer to FIG. 1).

A program sequence of the 2-plane program operation request provided to the host interface 250 according to at least one example embodiment of inventive concepts may be the same as a program sequence of a 2-plane program operation request of a general planar NAND flash memory device.

FIG. 9 is a diagram schematically illustrating a sequence corresponding to a 1-plane program operation request output from a VNAND interface 260 according to at least one example embodiment of inventive concepts. Referring to FIG. 9, a VNAND interface 260 interprets a 2-plane program operation request provided to a host interface 250 as a program operation request for a plane supporting a high-speed operation mode, and outputs a program sequence according to the program operation request thus interpreted.

Upon reception of a program operation request, as illustrated in FIG. 9, a program sequence start command 80h and an address CCRRR for a same page and LSB page data are sequentially transferred. Next, a page data exchange command (or, “dumping command”) P for a latch operation of a page buffer is transferred, so that a latch operation may be executed during a time tLCH.

Then, a program sequence start command 80h and an address CCRRR for the same page and MSB page data are sequentially transferred. Next, a page data exchange command P for a latch operation of a page buffer is transferred, so that a latch operation is executed during a time tLCH. Finally, a program sequence end command Confirm PGM may be sent.

With the program sequence output from the VNAND interface 260 according to at least one example embodiment of inventive concepts, a high-speed operation mode is supported by programming LSB page data and MSB page data at the same page at a time. A program sequence of the VNAND interface 260 is different from that of a host interface 250 shown in FIG. 8.

As described above, in FIGS. 8 and 9, there are described program sequences in which a multi-plane program operation request of a host is interpreted as a 1-plane operation request. However, inventive concepts are not limited thereto. A storage device 10 of inventive concepts may determine whether to interpret a multi-plane operation request transferred from the host as a multi-plane operation request or as a 1-plane operation request, based on information included in the multi-plane operation request.

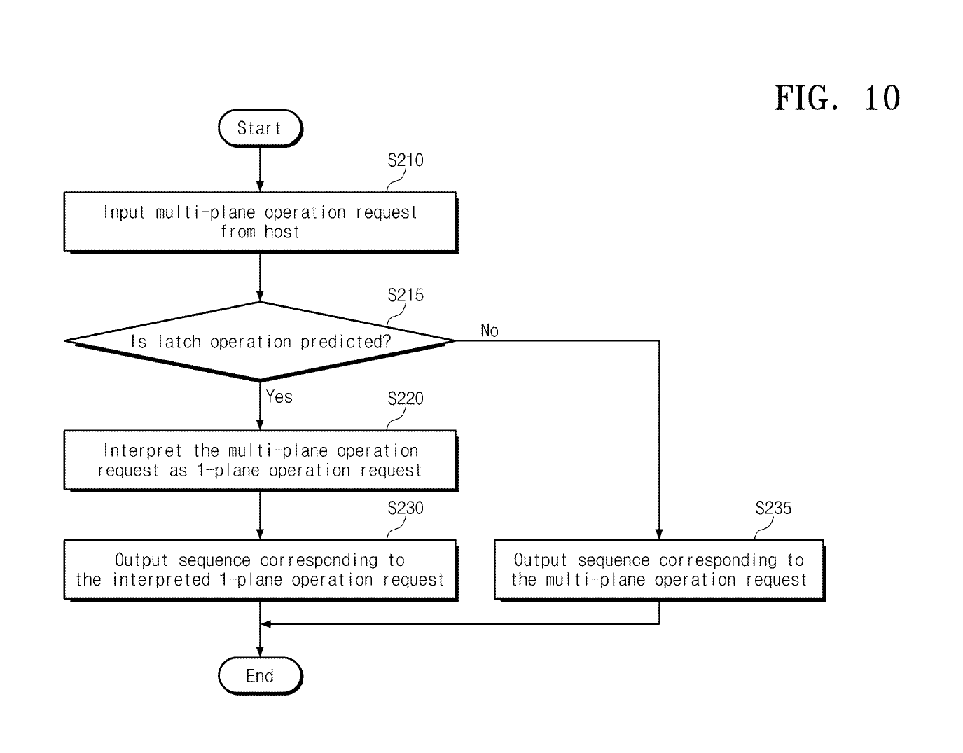

FIG. 10 is a flow chart schematically illustrating an operating method of a storage device 10, according to at least one example embodiment of inventive concepts. Below, an operating method of a storage device 10 will be more fully described with reference to FIG. 10.

In operation S210, a multi-plane operation request based on a NAND protocol is provided to a host interface 250 of a memory controller 200 (refer to FIG. 1). In operation S215, a VNAND interface 260 (refer to FIG. 1) determines whether a latch operation is predicted based on the input multi-plane operation request. Here, the latch operation may be predicted based on information included in a sequence start command for the input multi-plane operation request. For example, the memory controller 200 may determine whether to perform a multi-plane operation or a 1-plane operation of a VNAND 100 (refer to FIG. 1) based on the input sequence start command.

As a consequence of determining that a latch operation is predicted, in operation S220, the VNAND interface 260 interprets the multi-plane operation request as a 1-plane operation request based on a VNAND protocol. In operation S230, the VNAND interface 260 issues commands corresponding to the 1-plane operation request.

As a consequence of determining that a latch operation is not predicted, in operation S235, the VNAND interface 260 issues commands corresponding to the multi-plane operation request of the host interface 250 based on a VNAND protocol.

With the above description, the operating method of the storage device 10 includes predicting a latch operation and interpreting a multi-plane operation request provided from a host as a multi-plane operation request or a 1-plane operation request according to the prediction result.

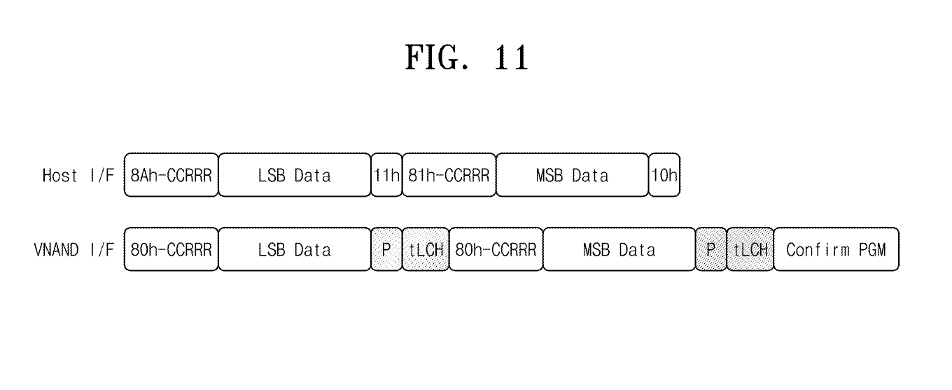

FIG. 11 is a diagram schematically illustrating a program sequence where a 2-plane program operation request of a host is interpreted as a 1-plane program operation request when a latch operation is predicted.

Referring to FIG. 11, after receiving a program operation request for a first plane, a host interface 250 (refer to FIG. 1) receives a program operation request for a second plane. A program sequence start command 8Ah for the first plane may include identification information that enables a multi-plane operation request of a host to be processed in a physical plane of a VNAND 100 (refer to FIG. 1). That is, the program sequence start command 8Ah may include identification information indicating whether to use a multi-plane program operation. A latch operation may be predicted based on the identification information. A program sequence provided to the host interface 250 is the same as that shown in FIG. 8, except for a program sequence start command 8Ah including identification information indicating whether to use a multi-plane of the VNAND 100.

A VNAND interface 260 (refer to FIG. 1) predicts a latch operation based on the program sequence start command 8Ah. For example, as illustrated in FIG. 11, if a multi-plane operation request is received from a host and a program sequence start command 8Ah indicating that a multi-plane of the VNAND 100 is not used is received, the VNAND interface 260 predicts that a latch operation supporting a high-speed operation mode is executed.

The VNAND interface 260 parses a program sequence start command 8Ah provided to the host interface 250 to interpret a 2-plane program operation request of a host as a program operation request for a plane of the VNAND 100. The VNAND interface 260 outputs a program sequence corresponding to the interpretation result. The program sequence output from the VNAND interface 260 may be the same as that described with reference to FIG. 9. For example, the program sequence may include a page data exchange command P and a time tLCH when a latch operation is performed.

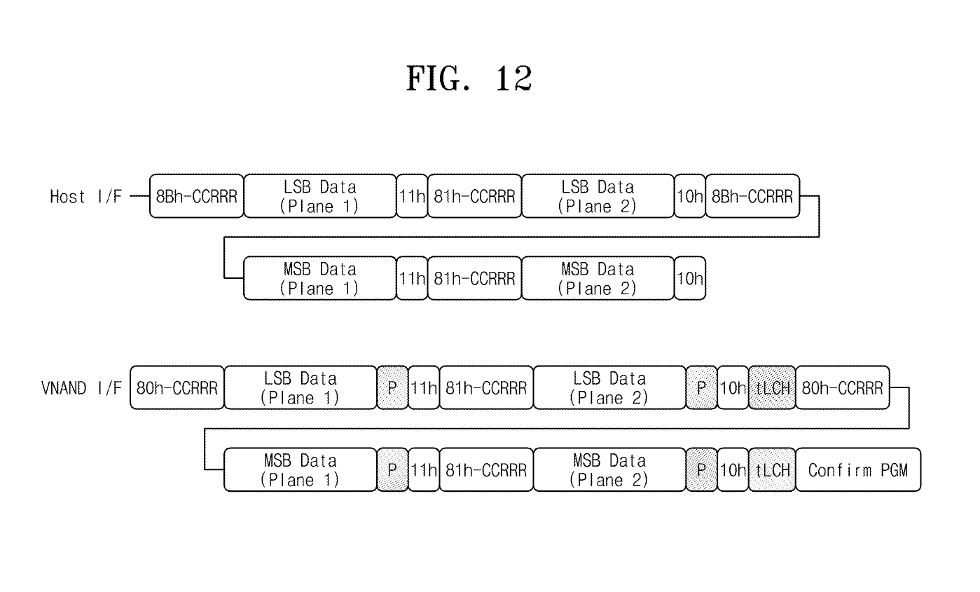

FIG. 12 is a diagram schematically illustrating a program sequence where a 2-plane program operation request of a host is interpreted as a 2-plane program operation request when a latch operation is not predicted. In FIG. 12, there is illustrated a program sequence for programming four pages of data.

Referring to FIG. 12, a program sequence start command 8Bh that initiates a program operation request for a first plane provided to a host interface 250 may be different from a program sequence start command 8Ah shown in FIG. 11. Herein, the program sequence start command 8Bh that initiates a program operation request for a first plane may include identification information that enables a 2-plane operation request of a host to be processed at two physical planes of a VNAND 100 (refer to FIG. 1). A latch operation may be predicted based on the identification information.

A program sequence for a 2-plane program operation request provided to the host interface 250 may include four program sequences as follows.

In a first program sequence, to program LSB page data at a page of a first plane, a program sequence start command 8Bh and an address CCRRR corresponding to the page are issued, and then, LSB page data and a data transfer completion command 11h are sequentially transferred. Afterwards, a second program sequence may commence.

In a second program sequence, to program LSB page data at a page of a second plane, a program sequence start command 81h and an address CCRRR corresponding to the page are issued, and then, LSB page data and a data transfer completion command 10h are sequentially transferred. Afterwards, a third program sequence may commence.

In a third program sequence, to program MSB page data at a page of the first plane, a program sequence start command 8Bh and an address CCRRR corresponding to the page are issued, and then, MSB page data and a data transfer completion command 11h are sequentially transferred. Afterwards, a fourth program sequence may commence.

In a fourth program sequence, to program MSB page data at a page of the second plane, a program sequence start command 81h and an address CCRRR corresponding to the page are issued, and then, MSB page data and a data transfer completion command 10h are sequentially transferred.

The VNAND interface 260 parses a start command 8Bh provided to the host interface 250 to interpret a 2-plane program operation request of a host as a program operation request for two physical planes. The VNAND interface 260 issues a program sequence according to the interpretation result. In particular, the VNAND interface 260 parses a start command 8Bh to predict whether to perform a latch operation and assigns a latch time to a program sequence.

A program sequence output from the VNAND interface 260 may include four continuous program sequences as follows. Here, the four continuous program sequences may be executed in turn with respect to planes.

A first program sequence is issued for a first plane. In the first program sequence, after a program sequence command 80h and an address CCRRR for a page of the first plane are received, LSB data, a page data exchange command P, and a program sequence transfer completion command 11h are sequentially transferred. A program sequence for a second plane may commence after the program sequence for the first plane. Simultaneously the VNAND 100 performs a latch operation of a first page buffer (e.g., 130-1, refer to FIG. 3) for the first plane. Namely, LSB page data stored in latches corresponding to the first plane are transferred to other latches corresponding to the first plane. Thus, a time taken to perform a latch operation of the first page buffer 130-1 is not in the first program sequence for the first plane.

The second program sequence is issued for the second plane. In the second program sequence, after a program sequence command 81h and an address CCRRR for a page of the second plane are received, LSB data, a page data exchange command P and a program sequence transfer completion command 10h are sequentially transferred. A latch operation is performed during a time tLCH. Here, during the time tLCH, the VNAND 100 preforms a latch operation of a second page buffer (e.g., 131-2 refer to FIG. 3) for the second plane. Namely, LSB page data stored in latches corresponding to the second plane are transferred to other latches corresponding to the second plane. Thus, the page buffer circuits 130-1, 130-2 may be prepared to store new data (i.e., MSB data) during the time tLCH.

A third program sequence is issued for the first plane. In the third program sequence, after a program sequence command 80h and an address CCRRR for a page of the first plane are received, MSB data, a page data exchange command P, and a program sequence transfer completion command 11h are sequentially transferred. A program sequence for the second plane may commence after the program sequence for the first plane. Simultaneously the VNAND 100 performs a latch operation of the first page buffer 131-1 for the first plane. Namely, MSB page data stored in latches corresponding to the first plane are transferred to other latches corresponding to the first plane. Thus, a time taken to perform a latch operation of the first page buffer 130-1 is not in the third program sequence for the first plane.

Afterwards, the fourth program sequence is issued for the second plane. In the second program sequence, after a program sequence command 81h and an address CCRRR for a page of the second plane are received, MSB data, a page data exchange command P and a program sequence transfer completion command 10h are sequentially transferred. After a latch operation is performed during a time tLCH, a program sequence end command Confirm PGM is issued. Meanwhile, a latch time tLCH of the fourth program sequence may be removed.

The VNAND interface 260 according to at least one example embodiment of inventive concepts predicts a latch operation based on a multi-plane program sequence start command 8Bh to allocate a latch operation time tLCH to a program sequence.

Meanwhile, a storage device 10 according to at least one example embodiment of inventive concepts may further comprise a latency reducing unit for reducing a latency that occurs at a program/read operation sequence.

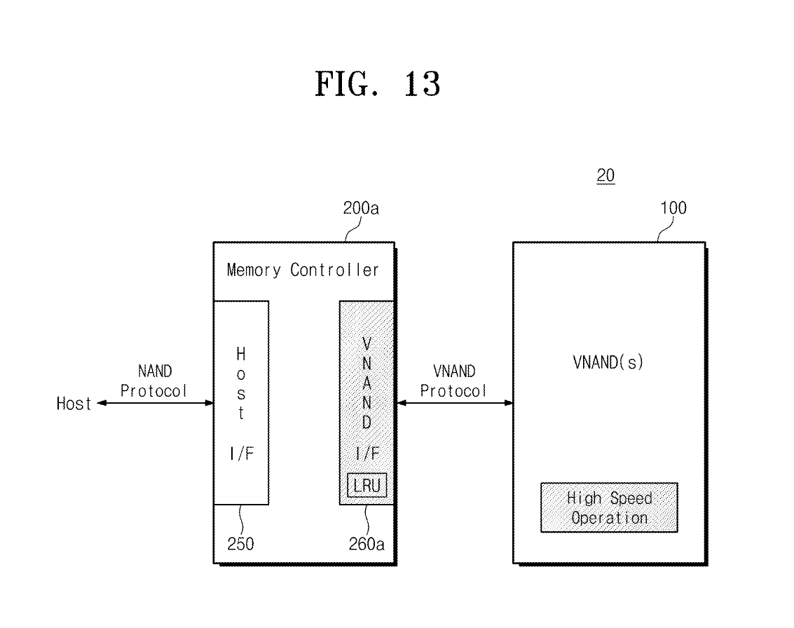

FIG. 13 is a block diagram schematically illustrating a storage device according to at least one example embodiment of inventive concepts. Referring to FIG. 13, a storage device 20 contains a VNAND 100 and a memory controller 200a. The memory controller 200a is substantially the same as that shown in FIG. 1 except a VNAND interface 260a includes a latency reducing unit LRU (or latency reducing device).

The latency reducing unit LRU may be a device that reduces latency occurring upon an operation request. For example, upon a program operation request, the latency reducing unit LRU senses a page data transfer to instantly issue a page exchange command.

In at least one example embodiment, an operation of the latency reducing unit LRU may be optional. For example, an operation of the latency reducing unit LRU may be activated by a request of a user, according to a variation in use circumstance, or by a user of a storage device.

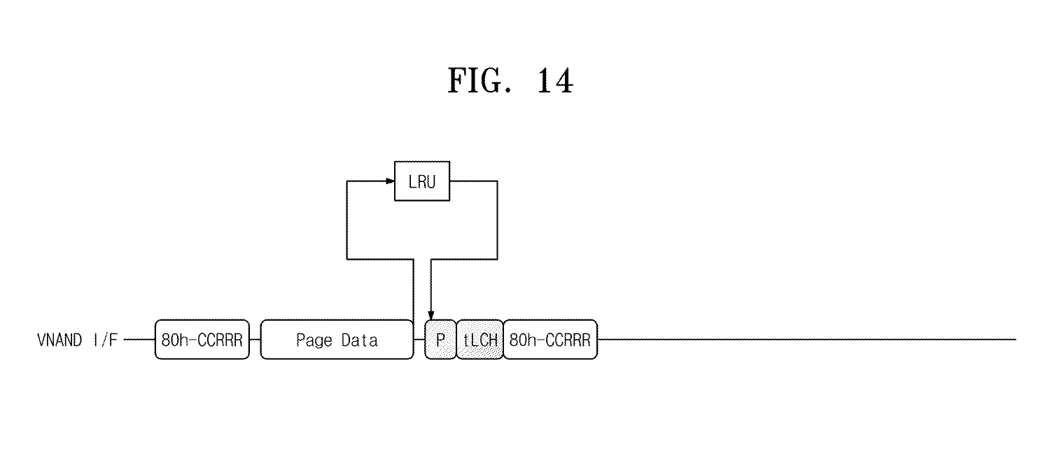

FIG. 14 is a diagram for conceptually describing an operation of a latency reducing unit LRU shown in FIG. 13. Referring to FIG. 14, a latency reducing unit LRU senses, on a data channel, a transfer completion of LSB data according to a program operation request sequence and controls a VNAND interface 260a (refer to FIG. 13) to issue a page data exchange command P immediately when a transfer completion is sensed.

A storage device according to at least one example embodiment of inventive concepts checks an occupied state of a write buffer and receives data from a host according to the checking result.

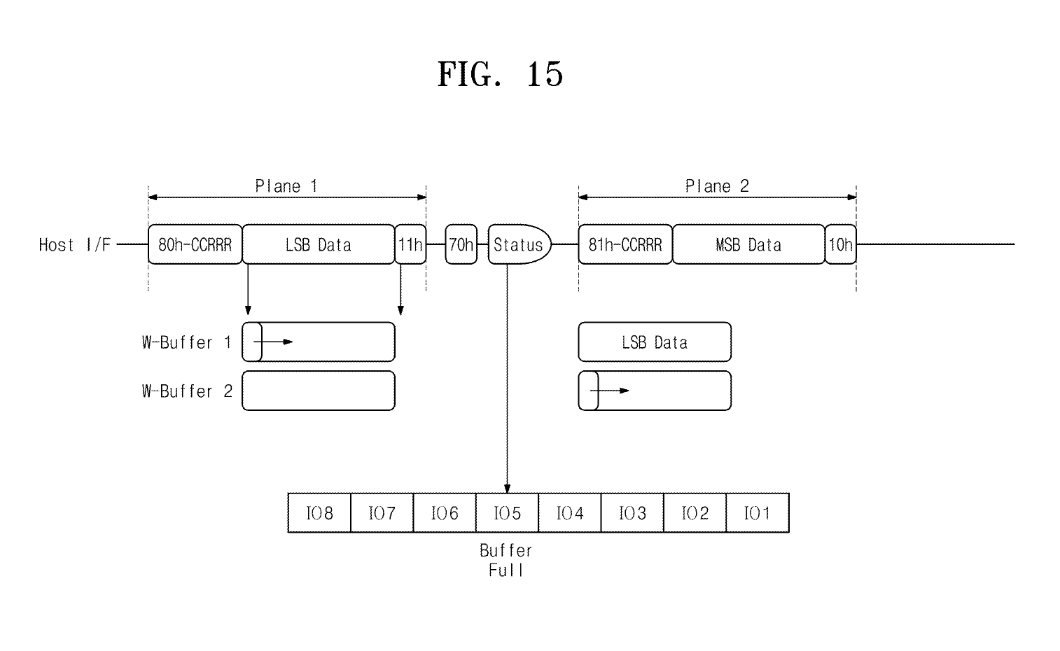

FIG. 15 is a diagram schematically illustrating a program sequence of transferring data based on a result of checking whether a buffer is full, in a storage device according to at least one example embodiment of inventive concepts. Referring to FIG. 15, after a program operation request for a first logical plane, a status read command 70h for checking a status of a buffer is issued, and a following data transfer for a second logical plane is determined according to a result of the status of channels based on the status read command 70h. For example, if the status check indicates that the write buffer (e.g., W-Buffer 1 of memory controller 200) is full, then the memory controller 200 continues receives a program operation request for a second logical plane by storing MSB data to W-Buffer 2 of memory controller 200. If the status check indicates that the write buffer W-Buffer 1 is not full, then the memory controller may receive the program operation request for the second logical plane by storing some of the MSB data to W-Buffer 1.

Meanwhile, inventive concepts are not limited to a storage device using a VNAND architecture. Inventive concepts are applicable to a storage device using any type of NAND flash memory device with a new interface.

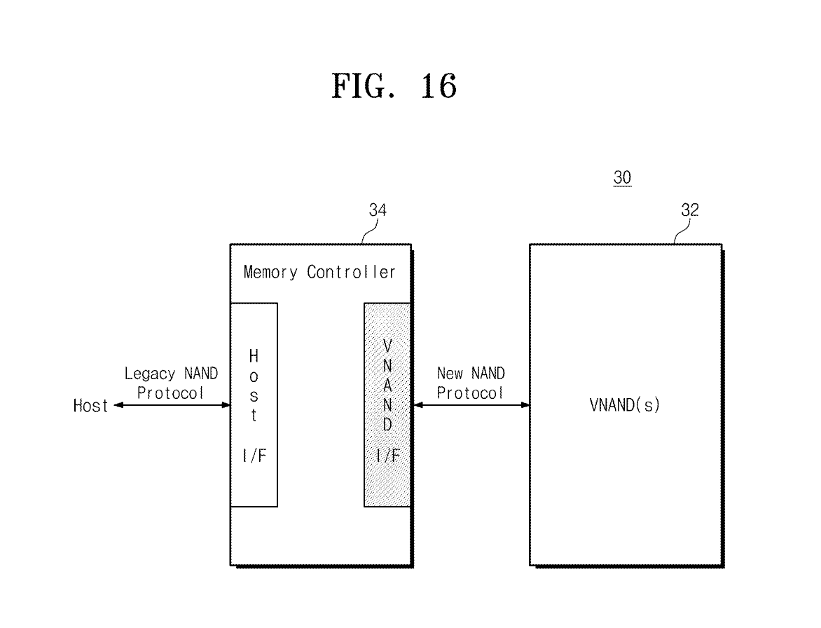

FIG. 16 is a block diagram schematically illustrating a storage device 30 according to at least one example embodiment of inventive concepts. Referring to FIG. 16, a storage device 30 contains a NAND flash memory device 32 and a memory controller 34 to control the NAND flash memory device 32.

In at least one example embodiment, the NAND flash memory device 32 may support an on-chip buffered program (OBP) operation. Here, with the on-chip buffered program operation, data to be programmed is temporarily stored in a buffer memory (e.g., a buffer memory of the memory controller 34 or a storage space of the NAND flash memory device 32), and a multi-bit program operation is carried out later. Here, the on-chip buffered program operation may be performed in a high-speed operation mode described with reference to FIG. 2.

The memory controller 34 includes a host interface to communicate with a host using a legacy NAND protocol and a NAND interface to communicate with the NAND flash memory device 32 using a new NAND protocol.

In at least one example embodiment, a clock used for the new NAND protocol is faster than that used for the legacy NAND protocol.

In accordance with the above description, the storage device 30 according to at least one example embodiment of inventive concepts interprets the legacy NAND protocol as the new NAND protocol, and outputs an operation sequence for issuing control signals and commands suitable for the new NAND protocol. Thus, the storage device 30 maintains compatibility with a storage device that uses a conventional NAND flash memory device.

It should be understood that inventive concepts are applicable to a solid state drive (SSD).

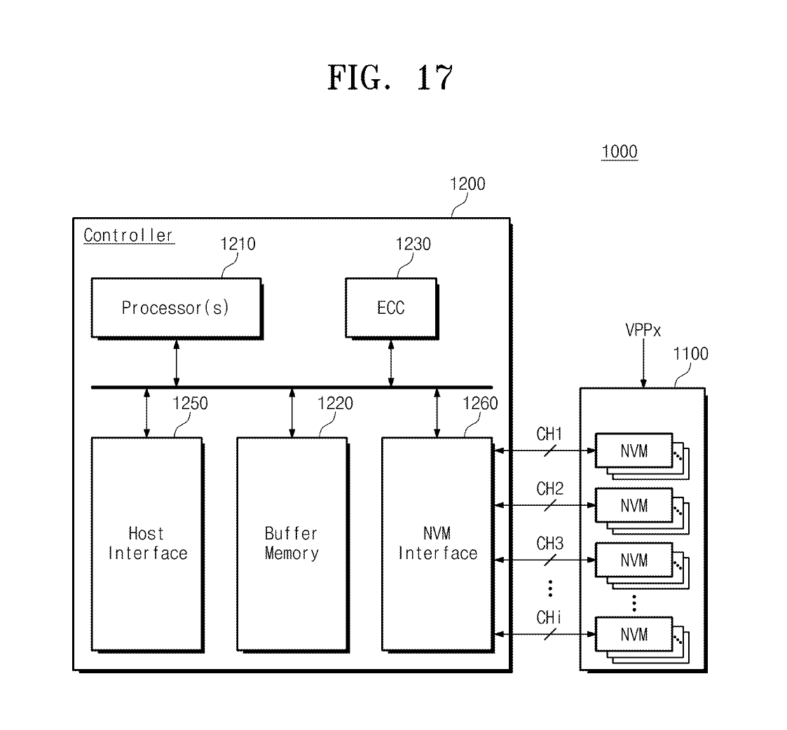

FIG. 17 is a block diagram schematically illustrating a solid state drive according to at least one example embodiment of inventive concepts. Referring to FIG. 17, a solid state drive (hereinafter, referred to as SSD) 1000 includes a plurality of nonvolatile memory devices 1100 and an SSD controller 1200. Each of the nonvolatile memory devices 1100 is implemented with a VNAND 100 shown in FIG. 1 or a NAND flash memory device 32 shown in FIG. 16. The nonvolatile memory devices 1100 are implemented to be provided with an external high voltage VPPx optionally. The SSD controller 1200 is connected to the nonvolatile memory devices 1100 through a plurality of channels CH1 to CHi (i being an integer of 2 or more). The SSD controller 1200 includes one or more processors 1210, a buffer memory 1220, an ECC block 1230, a host interface 1250, and a nonvolatile memory interface 1260.

The buffer memory 1220 stores data needed to drive the SSD controller 1200. In at least one example embodiment, the buffer memory 1220 may include a plurality of memory lines each of which stores data or a command. Here, the plurality of memory lines may be mapped onto cache lines according to a variety of methods.

The ECC block 1230 calculates error correction code values of data to be programmed in a writing operation and corrects an error of read data using an error correction code value in a read operation. In a data recovery operation, the ECC block 1230 may correct an error of data recovered from the nonvolatile memory devices 1100. Although not shown in FIG. 17, a code memory may be further included to store code data needed to drive the SSD controller 1200. The code memory may be implemented with a nonvolatile memory device.

The host interface 1250 provides an interface with an external device. The host interface 1250 may be a NAND flash interface. The host interface 1250 may be implemented the same as a host interface 250 shown in FIG. 1, 13, or 16.

The nonvolatile memory interface 1260 provides an interface with the nonvolatile memory devices 1100. Here, the nonvolatile memory interface 1260 may be implemented the same as a VNAND interface shown in FIG. 1, 13, or 16.

The SSD 1000 according to at least one example embodiment of inventive concepts may be suitable for a server-oriented storage device because it supports a high-speed operation mode and maintains compatibility with a storage device formed of a conventional NAND flash memory device.

Inventive concepts are also applicable to an eMMC (e.g., an embedded multimedia card such as moviNAND, iNAND, etc.).

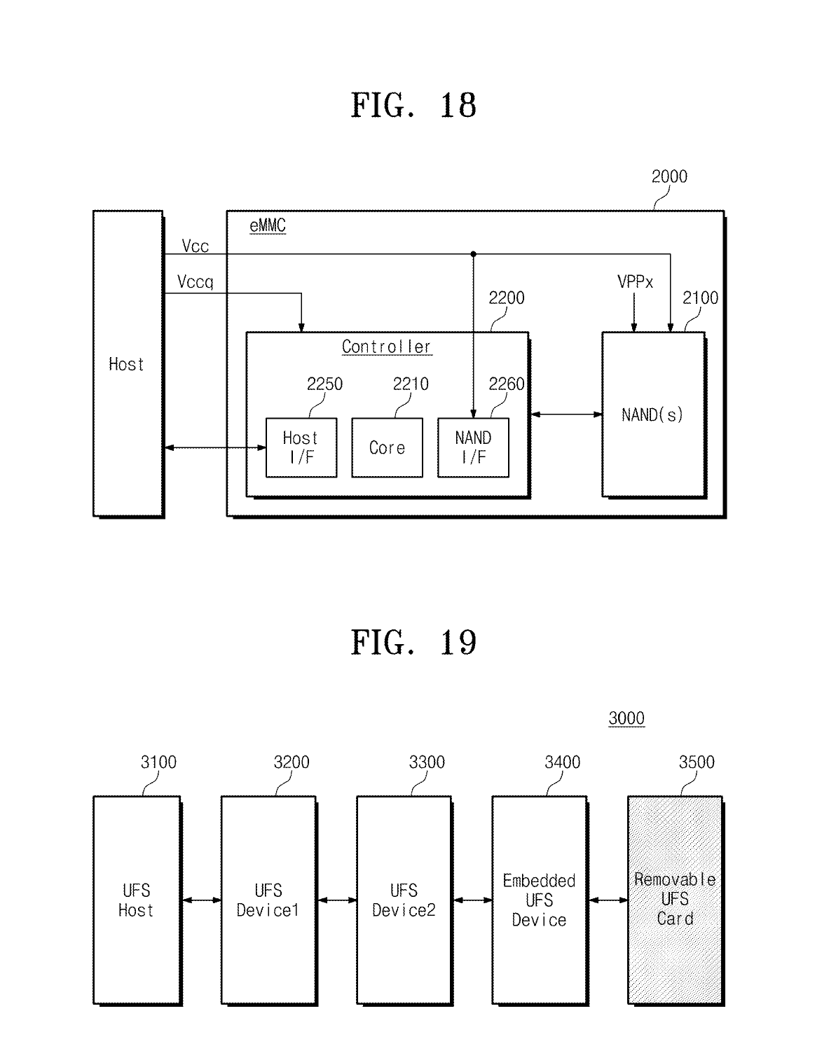

FIG. 18 is a block diagram schematically illustrating an eMMC according to at least one example embodiment of inventive concepts. Referring to FIG. 18, an eMMC 2000 includes one or more NAND flash memory devices 2100 and a controller 2200.

The NAND flash memory device 2100 is a single data rate (SDR) NAND flash memory device or a double data rate (DDR) NAND flash memory device. Or, the NAND flash memory device 2100 is a vertical NAND flash memory device (VNAND). The controller 2200 is connected to the NAND flash memory device 2100 via a plurality of channels. The controller 2200 includes one or more controller cores 2210, a host interface 2250, and a NAND interface 2260. The controller core 2210 may control an overall operation of the eMMC 2000.

The host interface 2250 is configured to perform an interface between the controller 2210 and a host. The host interface 2250 may be a host interface shown in FIG. 1, 13, or 16.

The NAND interface 2260 is configured to provide an interface between the NAND flash memory device 2100 and the controller 2200. In at least one example embodiment, the NAND interface 2260 may be implemented the same as a NAND interface shown in FIG. 1, 13, or 16.

The eMMC 2000 receives power supply voltages Vcc and Vccq from the host. Herein, the power supply voltage Vcc (e.g., about 3.3 V) may be supplied to the NAND flash memory device 2100 and the NAND interface 2260, and the power supply voltage Vccq (e.g., about 1.8 V/3.3 V) may be supplied to the controller 2200. In at least one example embodiment, the eMMC 2000 may be optionally supplied with an external high voltage.

The eMMC 200 according to at least one example embodiment of inventive concepts processes an input/output request of a host using a NAND protocol externally and an input/output request using a protocol suitable for the NAND flash memory device 2100 internally.

Inventive concepts are applicable to universal flash storage (UFS).

FIG. 19 is a block diagram schematically illustrating a UFS system according to at least one example embodiment of inventive concepts. Referring to FIG. 19, a UFS system 3000 includes a UFS host 3100, UFS devices 3200 and 3300, an embedded UFS device 3400, and a removable UFS card 3500. The UFS host 3100 may be an application processor of a mobile device. Each of the UFS host 3100, the UFS devices 3200 and 3300, the embedded UFS device 3400, and the removable UFS card 3500 may communicate with external devices through the UFS protocol. At least one of the UFS devices 3200 and 3300, the embedded UFS device 3400, and the removable UFS card 3500 may be implemented with a storage device 10 shown in FIG. 1, 13, or 16.

Meanwhile, the embedded UFS device 3400 and the removable UFS card 3500 may perform communications using protocols different from the UFS protocol. The UFS host 3100 and the removable UFS card 3500 may communicate through various card protocols (e.g., UFDs, MMC, SD (secure digital), mini SD, Micro SD, etc.).

Inventive concepts are also applicable to a mobile device.

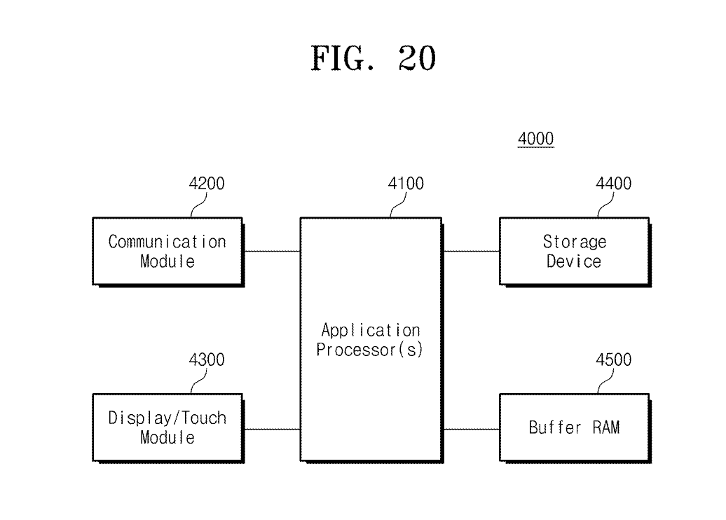

FIG. 20 is a block diagram schematically illustrating a mobile device 4000 according to at least one example embodiment of inventive concepts. Referring to FIG. 20, a mobile device 4000 includes an application processor 4100, a communication module 4200, a display/touch module 4300, a storage device 4400, and a buffer RAM 4500.

The application processor 4100 controls an overall operation of the mobile device 4000. The communication module 4200 is implemented to perform wireless or wire communications with an external device. The display/touch module 4300 is implemented to display data processed by the application processor 4100 or to receive data through a touch panel. The storage device 4400 is implemented to store user data. The storage device 4400 may be, but not limited to, a memory card, an eMMC, an SSD, or an UFS device. The storage device 4400 may be implemented with a storage device shown in FIG. 1, 13, or 16. The buffer RAM 4500 is configured to temporarily store data needed for a processing operation of the mobile device 4000.

The mobile device 4000 according to at least one example embodiment of inventive concepts includes the storage device 4400 to perform a high-speed operation mode, so its performance of system is improved.

A memory system and/or a storage device according to the inventive concept may be packaged according to any of a variety of different packaging technologies. Examples of such packaging technologies may include PoP (Package on Package), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Small Outline Integrated Circuit (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), and the like.

While inventive concepts have been described with reference to example embodiments, it will be apparent to those skilled in the art that various changes and modifications may be made without departing from the spirit and scope of inventive concepts. Therefore, it should be understood that the above example embodiments are not limiting, but illustrative.

1-10. (canceled)

11. A storage device comprising:
at least one vertical NAND flash memory device (VNAND) including a plurality of memory blocks formed of a plurality of strings, the plurality of strings being in a direction perpendicular to a substrate and connected to a bit line, each string of the plurality of strings including at least one string selection transistor, a plurality of memory cells, and at least one ground selection transistor; and
a memory controller configured to control the at least one VNAND,
wherein the memory controller includes,
a host interface configured to communicate with a host using a NAND protocol; and
a VNAND interface configured to communicate with the at least one VNAND using a VNAND protocol, and
wherein the VNAND interface is configured to interpret an operation request received through the host interface as one of a multi-plane operation request and a 1-plane operation request.

12. The storage device of claim 11, wherein the at least one VNAND supports a high-speed operation mode in which a plurality of page data is programmed to or read from a physical page at one time.

13. The storage device of claim 11, wherein the VNAND interface is configured to determine whether to perform a latch operation based on the operation request received from a host, and interpret the received operation request as the multi-plane operation request or the 1-plane operation request according to the determination result.

14. The storage device of claim 11, wherein the host interface is configured to use a start command that is distinguishable by plane information in the operation request.

15. The storage device of claim 11, wherein the VNAND interface comprises:
a latency reducing device configured to sense a page data transfer for at least one channel and to issue a page data exchange command for a high-speed operation node based on the sensing result.

16. A mobile device comprising:
an application processor; and
a storage device configured to communicate with the application processor via a first NAND interface,
wherein the storage device includes at least one vertical NAND flash memory device (VNAND) and a memory controller configured to communicate with the at least one VNAND via a second NAND interface, and
wherein the second NAND interface is configured to interpret an operation request received via the first NAND interface as one of a multi-plane operation request and a 1-plane operation request.

17. The mobile device of claim 16, wherein the storage device is a UFS (universal flash storage) device.

18. The mobile device of claim 16, wherein the first NAND interface is configured to receive a part of the operation request according to a status of a write buffer.

19. The mobile device of claim 16, wherein the second NAND interface is configured to issue at least one page data exchange command in the 1-plane operation request.

20. The mobile device of claim 19, wherein the second NAND interface is configured to issue the at least one page data exchange command in response to a transfer completion of write data.

21. A device comprising:
a memory controller configured to,
receive a first sequence of commands for performing an operation on a memory associated with the memory controller, the first sequence of commands being received in accordance with a first protocol,
convert the first sequence of commands into a second sequence of commands such that the second sequence of commands is in accordance with a second protocol, different from the first protocol, and
output the second sequence of commands such that the operation is performed on the memory.

22. The memory controller of claim 21, wherein the first protocol is for a planar NAND flash memory device, and the second protocol for a vertical NAND flash memory device.

23. The memory controller of claim 21, wherein the received first sequence of commands is a request for performing the operation on a plurality of logical pages of data, and the second sequence of commands is a request for performing the operation on one physical page of data in the memory.

24. The memory controller of claim 23, wherein the first sequence of commands is a program operation request including,
a first start command and a first address of a first logical page of the plurality of logical pages,
page data of the first logical page,
a transfer completion command for the first logical page,
a second start command and a second address of a second logical page of the plurality of logical pages,
page data of the second logical page, and
a transfer completion command for the second logical page.

25. The memory controller of claim 24, wherein the second sequence of commands is a program operation request including,
a third start command and a first address of the one physical page,
the page data of the first logical page,
a first page data exchange command for performing a first latch operation,
a fourth start command and a second address of the one physical page,
the page data of the second logical page,
a second data exchange command for performing a second latch operation, and
a transfer completion command for the one physical page.

26. The memory controller of claim 25, wherein the memory controller is configured to sense a transfer completion of the page data of the first logical page and immediately initiate the first page data exchange command upon sensing the transfer completion.

27. The memory controller of claim 25, wherein the memory controller is configured to predict the latch operation, and convert the first sequence of commands into the second sequence of command based on a result of the prediction.

28. The memory controller of claim 27, wherein the first start command includes identification information, and the memory controller is configured to predict the latch operation based on the identification information.
